(19) United States
(12) Patent Application Publication
(10) Pub. No.: US 2015/0326083 A1
(43) Pub. Date: Nov. 12, 2015

(54) COOLING STRUCTURE FOR MOTOR

(71) Applicant: MANDO CORPORATION, Pyeongtaek-si (KR)

(72) Inventor: Baik Kee SONG, Seongnam-si (KR)

(73) Assignee: MANDO CORPORATION, Pyeongtaek-si (KR)

(21) Appl. No.: 14/706,735

(22) Filed: May 7, 2015

(30) Foreign Application Priority Data
May 9, 2014 (KR) 10-2014-0055843

(51) Int. Cl. H02K 3/24

(52) U.S. Cl. CPC H02K 3/24

(57) ABSTRACT

A cooling structure for a motor includes: a stator in which a plurality of teeth are arranged along an inner circumference of a hollow at which a rotor is disposed, and spacing portions are formed between the teeth; coils individually wound around outer circumferences of the teeth and configured to generate a magnetic force by external power; and cooling tubes individually wound around the teeth to surround outer circumferences of the coils and configured to cool the coils by circulating a refrigerant supplied from the outside.

### CROSS-REFERENCE(S) TO RELATED APPLICATION

This application claims priority of Korean Patent Application No. 10-2014-0055843, filed on May 9, 2014, in the Korean Intellectual Property Office, which is hereby incorporated by reference in its entirety.

### BACKGROUND OF THE INVENTION

1. Field of the Invention

The present invention relates to a cooling structure for a motor, and more particularly, to a cooling structure for a motor in which a cooling tube for refrigerant circulation is wound on an outer surface of a coil, such that the cooling tube directly cools the coil, thus improving cooling performance.

2. Description of the Related Art

Generally, motors are devices that convert electrical energy into mechanical energy to acquire rotational power. The motors are classified into DC motors and AC motors according to a type of external power. The motor includes a stator and a rotor (or an armature).

The motor operates based on the principle that the rotational torque is generated in the rotor by a rotating magnetic field generated when a current flows through a wound coil.

Since heat is generated in a coil, a conventional motor is provided with a cooling structure. A conventional cooling structure for a motor uses a water jacket system that circulates a refrigerant through an inner passage of a housing.

By the way, the conventional cooling structure for the motor is complicated because it is necessary to configure the passage inside the housing, and a direct cooling is difficult because a distance between the coil and the passage is long.

As a prior art document associated with the present invention, Korean Patent Publication No. 10-2014-0011449 (Jan. 28, 2014) discloses a cooling structure for a motor.

### SUMMARY OF THE INVENTION

An aspect of the present invention is directed to a cooling structure for a motor, in which a cooling tube for refrigerant circulation is wound on an outer surface of a coil, such that the cooling tube directly cools the coil, thus improving cooling performance.

Another aspect of the present invention is directed to a cooling structure for a motor, which is easily applicable to an existing structure and causes no great increase in a weight of a stator, so that cooling efficiency is maximized and manufacturing costs are not greatly increased.

According to the present invention, a cooling structure for a motor includes: a stator in which a plurality of teeth are arranged along an inner circumference of a hollow at which a rotor is disposed, and spacing portions are formed between the teeth; coils individually wound around outer circumferences of the teeth and configured to generate a magnetic force by external power; and cooling tubes individually wound around the teeth to surround outer circumferences of the coils and configured to cool the coils by circulating a refrigerant supplied from the outside.

Each of the cooling tubes may include one or more expanded tube portions formed along a longitudinal direction so as to come into contact with a part of the coil over a large area.

The expanded tube portion may protrude from both sides of the cooling tube in a longitudinal direction and have an elliptical shape.

The expanded tube portion may be formed in an upper or lower end of the coil that winds upper and lower ends of the teeth.

The cooling tubes may be individually wound around the outer circumferences of the coils, and adjacent portions of the cooling tubes may continuously communicate with one another.

The cooling tubes may be made of a non-conductive material.

The cooling tubes may be made of a silicone material.

Each of the cooling tubes may include: a first refrigerant inlet port formed at one end in a longitudinal direction; and a first refrigerant outlet port formed at the other end opposite to the first refrigerant inlet port.

The cooling structure may further include a housing disposed outside the stator and connected to a refrigerant supply part, wherein the housing includes: a second refrigerant inlet port connected to the first refrigerant inlet port; and a second refrigerant outlet port connected to the first refrigerant outlet port.

### BRIEF DESCRIPTION OF THE DRAWINGS

FIG. 1 is an assembled perspective view illustrating a cooling structure for a motor according to the present invention.

FIG. 2 is a plan view illustrating the cooling structure for the motor according to the present invention.

FIG. 3 is a front cross-sectional view illustrating a cooling structure for a motor according to the present invention.

FIG. 4 is a perspective view illustrating a cooling tube in the cooling structure for the motor according to the present invention.

### DETAILED DESCRIPTION OF EXEMPLARY EMBODIMENTS

Exemplary embodiments of the present invention will be described below in detail with reference to the accompanying drawings.

The advantages and features of the present invention and methods for achieving them will become more apparent from the following embodiments that are described in detail in conjunction with the accompanying drawings.

However, the present invention is not limited to the following embodiments and may be embodied in various forms. These embodiments are provided so that this disclosure will be thorough and complete, and will fully convey the scope of the invention to those skilled in the art. The scope of the present invention is defined by the appended claims.

Therefore, detailed descriptions of well-known technologies will be omitted since they would unnecessarily obscure the subject matters of the present invention.

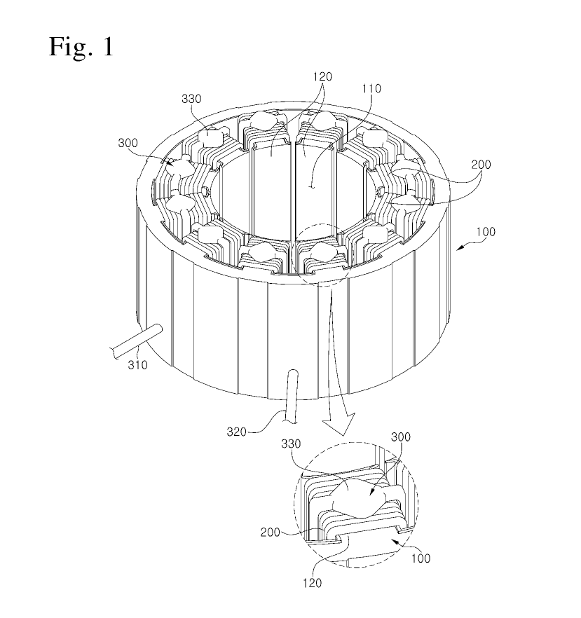

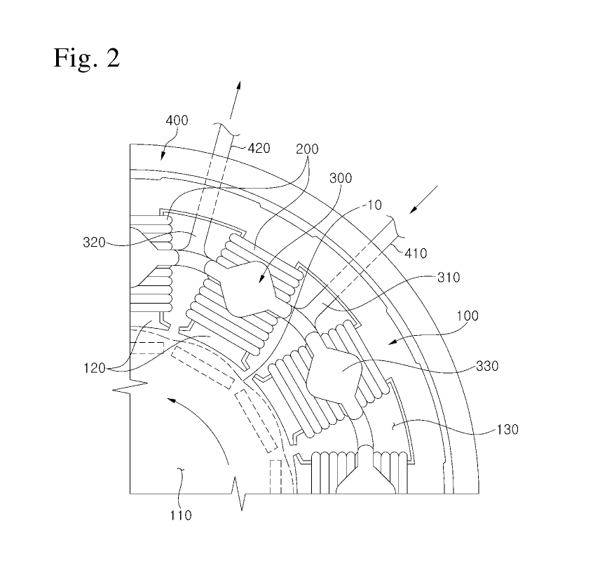

FIG. 1 is an assembled perspective view illustrating a cooling structure for a motor according to the present invention, and FIG. 2 is a plan view illustrating the cooling structure for the motor according to the present invention.

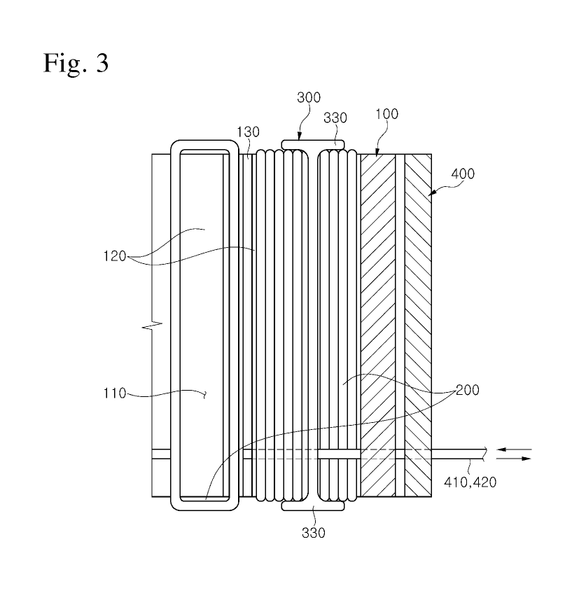

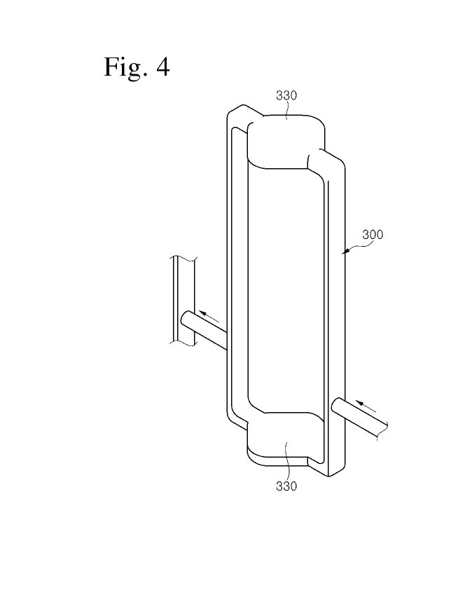

FIG. 3 is a front cross-sectional view illustrating a cooling structure for a motor according to the present invention, and FIG. 4 is a perspective view illustrating a cooling tube in the cooling structure for the motor according to the present invention.

Referring to FIGS. 1 to 4, the cooling structure for the motor according to the present invention includes a rotor 10, a stator 100, coils 200, and cooling tubes 300. In addition, a housing 400 is connected to the outside of the stator 100.

The stator 100 is fixedly installed in the housing 400 to be described below. The stator 100 may have a cylindrical shape with a hollow.

The rotor 10, which is connected to a driving shaft (not illustrated) of the motor, is rotatably installed in the hollow of the stator 100.

In addition, a plurality of teeth 120 protrude along an inner circumferential surface of the stator 100. Front ends of the teeth 120 may be formed to have a wider area as compared with the other portions.

Furthermore, spacing portions 130 are formed between teeth 120. The spacing portions 130 may be formed at regular intervals.

The spacing portions 130 may be formed to have various areas and shapes according to the number of the teeth 120.

The coils 200 are individually wound around the outer circumferences of the teeth 120, and the coils 200 generate a magnetic force by external power.

For example, when power is supplied to the coils 200, magnetic flux by the coils 20 and magnetic flux by magnetic materials generate a rotational force of the rotor 10.

As illustrated in FIGS. 1 and 2, the cooling tubes 300 are individually wound around the outer circumferences of the coils 200. The cooling tubes 300 cool the coils 200 by circulating a refrigerant supplied from the outside.

In this case, each of the cooling tubes 300 includes a first refrigerant inlet port 310 formed at one end in a longitudinal direction and a first refrigerant outlet port 320 formed at the other end opposite to the first refrigerant inlet port 310.

The cooling tubes 300 may be made of non-conductive materials. Preferably, the cooling tubes 300 are made of a heat-resistant silicone material.

The silicone material is suitable for easy installation because the silicon material is resistant to heat (200° C. or more) and is flexible.

Since the cooling tubes 300 made of the silicone material are also lightweight, the weight of the stator 100 is not greatly increased. The cooling tubes 300 can directly cool the coils 200 and can be applied to the existing stator, thereby reducing manufacturing costs.

In addition, due to the front ends of the teeth 120, the cooling tubes 300 may be latched between an inner circumferential surface of the stator 100 and the front ends of the teeth 120.

In particular, each of the cooling tubes 300 includes an expanded tube portion 330 formed by expanding a part thereof in order to cool a specific portion of the coil 200.

The expanded tube portion 330 is expanded to have an elliptical shape such that a curved passage is maintained along a longitudinal direction of the cooling tube 300. Thus, the expanded tube portion 330 may come into contact with the coil 200 over a large area.

The expanded tube portion 330 may be formed in upper and lower portions of the coil 200 directed in an axial direction of the stator 100.

In this state, the expanded tube portion 330 may intensively cool the upper or lower end of the coil 200 in the axial direction of the stator 100.

On the other hand, as illustrated in FIG. 3, the cooling tubes 300 may be continuously connected to one another while being individually wound around the outer circumferences of the coils 200.

For example, the refrigerant, which is supplied through the first refrigerant inlet port 310 of the cooling tube 300, may be circulated through the adjacent cooling tubes 300 and be discharged through the first refrigerant outlet port 320.

In this case, the coils 200, which are individually wound around the teeth 120, may be intensively cooled by the cooling tubes 300.

The housing 400 has a shape corresponding to the outside of the stator 100 and is connected to the stator 100 to thereby form an outer body. The housing 400 may be made of a metal material having a predetermined strength and a predetermined heat resistance.

The housing 400 is connected to a refrigerant supply unit (not illustrated) and may include a second refrigerant inlet port 410 connected to the first refrigerant inlet port 310 and a second refrigerant outlet port 420 connected to the first refrigerant outlet port 320.

According to the present invention, since the cooling tubes 300 for refrigerant circulation are wound around the outer surfaces of the coils 200, the cooling tubes 300 can directly cool the coils 200, thus improving cooling performance and reducing a size of a device.

In addition, since the cooling structure for the motor according to the present invention can be easily applied to an existing structure, manufacturing costs are not greatly increased while maximizing cooling efficiency.

Furthermore, since the cooling tubes 300 are made of the silicone material, no electricity flows through the cooling tubes 300. Thus, no electric short occurs and no separate insulating material is needed. Consequently, the weight of the stator is not greatly increased and the weight of the device is also not greatly increased accordingly.

The cooling structures for the motor according to the specific embodiments of the present invention have been described, but it is obvious that various modifications can also be made without departing from the scope of the present invention.

Therefore, the scope of the present invention should not be defined not by the detailed description of the embodiments but by the appended claims and their equivalents.

It should be understood that the above-described embodiments are exemplary in all aspects and are not intended to limit the scope of the present invention. It should be construed that the scope of the present invention is defined by the appended claims rather than the detailed description, and all changes and modifies derived from the meaning and scope of the claims and their equivalents will fall within the scope of the present invention.

### DESCRIPTION OF REFERENCE NUMERALS

| | |
|---|---|
| 10: rotor | 100: stator |
| 110: hollow | 120: teeth |
| 130: spacing portion | 200: coil |
| 300: cooling tube | 310: first refrigerant inlet port |
| 320: first refrigerant outlet port | 330: expanded tube portion |
| 400: housing | 410: second refrigerant inlet port |
| 420: second refrigerant outlet port | |

What is claimed is:

1. A cooling structure for a motor, comprising:
a stator in which a plurality of teeth are arranged along an inner circumference of a hollow at which a rotor is disposed, and spacing portions are formed between the teeth;
coils individually wound around outer circumferences of the teeth and configured to generate a magnetic force by external power; and
cooling tubes individually wound around the teeth to surround outer circumferences of the coils and configured to cool the coils by circulating a refrigerant supplied from the outside.

2. The cooling structure according to claim 1, wherein each of the cooling tubes includes one or more expanded tube portions formed along a longitudinal direction so as to come into contact with a part of the coil over a large area.

3. The cooling structure according to claim 2, wherein the expanded tube portion protrudes from both sides of the cooling tube in a longitudinal direction and has an elliptical shape.

4. The cooling structure according to claim 2, wherein the expanded tube portion is formed in an upper or lower end of the coil that winds upper and lower ends of the teeth.

5. The cooling structure according to claim 1, wherein the cooling tubes are individually wound around the outer circumferences of the coils, and adjacent portions of the cooling tubes continuously communicate with one another.

6. The cooling structure according to claim 1, wherein the cooling tubes are made of a non-conductive material.

7. The cooling structure according to claim 1, wherein the cooling tubes are made of a silicone material.

8. The cooling structure according to claim 1, wherein each of the cooling tubes includes:
a first refrigerant inlet port formed at one end in a longitudinal direction; and
a first refrigerant outlet port formed at the other end opposite to the first refrigerant inlet port.

9. The cooling structure according to claim 8, further comprising a housing disposed outside the stator and connected to a refrigerant supply part,
wherein the housing includes:
a second refrigerant inlet port connected to the first refrigerant inlet port; and
a second refrigerant outlet port connected to the first refrigerant outlet port.
